(19) United States
(12) Patent Application Publication
(10) Pub. No.: US 2021/0385177 A1
(43) Pub. Date: Dec. 9, 2021

(54) INFORMATION PROCESSING APPARATUS AND NON-TRANSITORY COMPUTER READABLE MEDIUM

(71) Applicant: FUJIFILM BUSINESS INNOVATION CORP., Tokyo (JP)

(72) Inventor: Kengo TOKUCHI, Kanagawa (JP)

(73) Assignee: FUJIFILM BUSINESS INNOVATION CORP., Tokyo (JP)

(21) Appl. No.: 17/069,966

(22) Filed: Oct. 14, 2020

(30) Foreign Application Priority Data
Jun. 4, 2020 (JP) 2020-097869

(51) Int. Cl. H04L 12/58

(52) U.S. Cl. CPC H04L 51/063; H04L 51/32

(57) ABSTRACT

An information processing apparatus includes a processor configured to: perform control so that processing is executed on content data in accordance with an attribute of a receiver of the content data; and send the content data to the receiver.

### CROSS-REFERENCE TO RELATED APPLICATIONS

This application is based on and claims priority under 35 USC 119 from Japanese Patent Application No. 2020-097869 filed Jun. 4, 2020.

### BACKGROUND

### (i) Technical Field

The present disclosure relates to an information processing apparatus and a non-transitory computer readable medium.

### (ii) Related Art

Japanese Unexamined Patent Application Publication No. 2014-63325 discloses the following server device. The server device stores image information uploaded by a certain registered user and identification information concerning the user having uploaded the image information in association with each other. In response to a request from this upload user or another registered user, the server device executes tagging processing for linking the image information uploaded by the upload user with a certain registered user. In this manner, the server device manages the association between image information and a registered user subjected to tagging processing.

Japanese Unexamined Patent Application Publication No. 2015-164076 discloses the following system. The system displays content obtained from various resources, executes processing for letting chat groups and contact addresses share the content, and also executes processing for letting outside social media share the content.

### SUMMARY

Content data, such as image data and document data, may be sent from a sender to a receiver.

Aspects of non-limiting embodiments of the present disclosure relate to making it possible to send content data to a receiver in the form of data suitable for this receiver.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a processor configured to: perform control so that processing is executed on content data in accordance with an attribute of a receiver of the content data; and send the content data to the receiver.

### BRIEF DESCRIPTION OF THE DRAWINGS

An exemplary embodiment of the present disclosure will be described in detail based on the following figures, wherein:

FIG. 1 is a block diagram illustrating an example of the configuration of an information processing system according to the exemplary embodiment;

FIG. 2 is a block diagram illustrating an example of the hardware configuration of a social networking service (SNS) server according to the exemplary embodiment;

FIG. 3 is a block diagram illustrating an example of the hardware configuration of a terminal device according to the exemplary embodiment;

FIG. 4 illustrates an example of a chat group management table;

FIG. 5 illustrates an example of a user attribute management table;

FIG. 6 illustrates an example of an attribute relationship management table;

FIG. 7 illustrates an example of a processing content management table;

FIG. 8 illustrates an example of processing according to the exemplary embodiment;

FIG. 9 illustrates a screen for user A;

FIG. 10 illustrates a screen for user B;

FIG. 11 illustrates a screen for user D;

FIG. 12 illustrates a screen for user B;

FIG. 13 illustrates a screen for user B; and

FIG. 14 illustrates a screen for user A.

### DETAILED DESCRIPTION

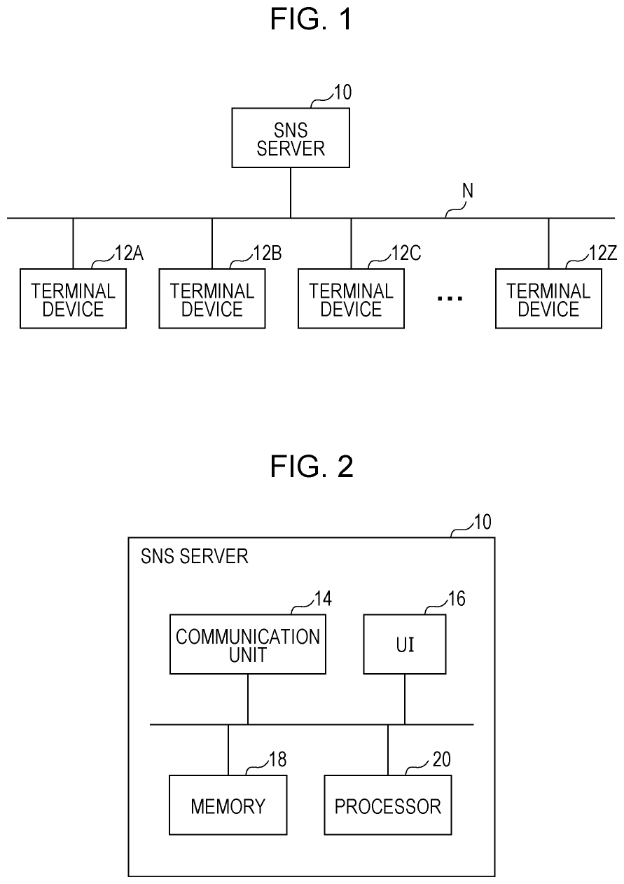

An information processing system according to an exemplary embodiment will be described below with reference to FIG. 1.

The information processing system according to the exemplary embodiment includes a social networking system (SNS) server 10 and one or multiple terminal devices, for example. In the example in FIG. 1, the information processing system includes terminal devices 12A, 12B, 12C, . . . , 12Z. The number of terminal devices is not restricted to that shown in FIG. 1, and the information processing system may include as many terminal devices as desired. Hereinafter, the terminal devices 12A, 12B, 12C, . . . , 12Z will simply be called the terminal device 12 or the terminal devices 12 unless it is necessary to distinguish them from each other. The information processing system may include a device other than the terminal devices, such as a server.

The SNS server 10 and the terminal devices 12 have a function of communicating with each other or another device. Communication performed between the devices may be wired communication using a cable or wireless communication. That is, the SNS server 10 and the terminal devices 12 may physically be connected to each other or another device with a cable and send and receive information with each other, or may send and receive information with each other via wireless communication. As wireless communication, short-range wireless communication or Wi-Fi (registered trademark) may be utilized Another wireless communication standard may be employed. Examples of short-range wireless communication are Bluetooth (registered trademark), radio frequency identifier (RFID), and near field communication (NFC). The SNS server 10 and the terminal devices 12 may communicate with each other or another device via a communication channel, such as a local area network (LAN) or the Internet. In the example in FIG. 1, the SNS server 10 and the terminal devices 12 are able to communicate via a communication channel N. An example of the communication channel N is the Internet.

The SNS server 10 is a server that provides a social networking service (SNS). SNS is a service, a platform, or a vehicle that facilitates and assists the building of social networks or social interaction between SNS members by helping them send and receive various types of information with each other. SNS also means a social networking site and is often used in the sense of social media. Some SNSs are based on a recommendation system in which a user is allowed to become a member only by an existing member's recommendation. Examples of SNS are Facebook (registered trademark), LINE (registered trademark), Twitter (registered trademark), Instagram (registered trademark), LinkedIn (registered trademark), and TikTok (registered trademark). The SNS discussed in the exemplary embodiment may have functions similar to those of an existing SNS and provide services similar to those provided by a known SNS.

An example of information sent and received on SNS is content data. Content data is text data (document data, for example) representing text, such as messages and comments, image data, such as still image data and video image data, sound data, or a combination thereof. The content can be sent, received, edited, and deleted on SNS.

The SNS server 10 provides one or plural social networking services. If multiple users use the same SNS, the SNS server 10 controls sending and receiving of content data among these multiple users via the same SNS. If multiple users use different SNSs, the SNS server 10 may control sending and receiving of content data between SNSs so as to control sending and receiving of content data between these multiple users using the different SNSs. For example, if user A is registered in SNS (1) and uses it and user B is registered in SNS (2) and uses it, the SNS server 10 controls sending and receiving of content data between SNS (1) and SNS (2) so as to control sending and receiving of content data between the user A and the user B via SNS (1) and SNS (2). More specifically, if the user A posts content data for the user B by using SNS (1), the SNS server 10 receives the posted content data and sends it to the user B via SNS (2). The posted content data is displayed on the terminal device 12 of the user B via SNS (2).

The SNS server 10 stores and manages user account information about member users registered in SNS. The user account information is information used by a registered member to log in and use a certain SNS. The user account information indicates an SNS ID and a password, for example. A registered member sends the user account information assigned to this member to the SNS server 10 so that it can log in and use a certain SNS.

The SNS server 10 may store and manage information concerning the relationships between members. Examples of such information are information concerning members indicating how close they are on SNS and how they are related to each other (such as friends).

An SNS member may be a single user or a group of plural users. In the exemplary embodiment, a scene where content data is sent and received between multiple users on SNS will be discussed, but this is only an example. Content data may be sent and received between one or plural users and one or plural groups or between plural groups.

A group is an organization, such as a company, a department within a company, a section within a department, a circle, such as a school club, a gathering of some people, or any other group of people. No limitation is imposed on the type of group and the number of people forming a group. Hierarchical levels may be set for a group. For example, a higher-level group, an intermediate-level group which belongs to the higher-level group, and a lower-level group which belongs to the intermediate-level group may be set for a group. For instance, each of a baseball club and a football club is a lower-level group. Sports clubs to which the baseball club and the football club belong are a higher-level group. A higher-level group, an intermediate-level group, and a lower-level group are only examples of hierarchical levels. Only a higher-level group and a lower-level group may be set for a group. More hierarchical levels may be set.

The terminal device 12 is a personal computer (PC), a tablet PC, a smartphone, or a cellular phone. The terminal device 12 is an example of an information processing apparatus. The terminal device 12 is used by a user to use an SNS. For example, user account information for a certain SNS is set in the terminal device 12 and is sent to the SNS server 10, and then, a user can log in the SNS.

In the exemplary embodiment, users A, B, C, . . . , Z use the respective terminal devices 12. For example, the user A uses the terminal device 12A, the user B uses the terminal device 12B, the user C uses the terminal device 12C, . . . , and the user Z uses the terminal device 12Z.

User account information about the user A and those about the user B, C, . . . , Z are stored in and managed by the SNS server 10. That is, the users A, B, C, . . . , Z are SNS members registered in SNS provided by the SNS server 10.

For example, the user A can log in and use SNS by operating the terminal device 12A. Likewise, the users B, C, . . . , Z can log in and use SNS by operating the respective terminal devices 12B through 12Z. Multiple users may use a single terminal device 12. For instance, multiple users may log in SNS and post content data by operating a single terminal device 12.

User account information about an automated response system, such as a chatbot, may also be managed by the SNS server 10, so that the automated response system can participate in SNS. For example, an automated response system serves as a response assistant which responds to a query from a user. The automated response system receives a message from a user on SNS, analyzes the content of the message, creates a response to the message, and gives this response on SNS. The automated response system is implemented by executing a program, for example. The program is stored in the SNS server 10, another server, or the terminal device 12. The automated response system may be automated response artificial intelligence (AI). Any type of algorithm may be used for AI. The automated response system is also an example of a member that can participate in SNS.

In the exemplary embodiment, a chat group is formed on SNS. A chat group is a group in which members send and receive content data. Content data posted on a chat group is sent to the members of the group. An SNS member may participate in plural chat groups. Content data posted on a chat group may be edited or deleted by a member of this group. A task, such as a specific meeting, may be set in a chat group, and multiple members may participate in the task and send and receive content data.

In the exemplary embodiment, content data is subjected to processing in accordance with an attribute of a receiver of this content data. Examples of the receiver of content data are an SNS user (receiver user), an SNS account (receiver account), and a terminal device 12 (receiver terminal device 12, for example). If multiple accounts are assigned to one user, the receiver of content data is an individual account.

Processing to be executed on content data may be changed in accordance with the relationship between the sender and the receiver of this content data. Examples of the sender of content data are an SNS user (sender user), an SNS account (sender account), and a terminal device 12 (sender terminal device 12, for example). If multiple accounts are assigned to one user, the sender of content data is an individual account.

If content data is sent to multiple receivers, such as if content data is sent to multiple receivers together, processing to be executed on the content data may be changed for each receiver in accordance with the relationship between the sender and the receiver of this content data.

Processing on content data may be executed by a sender (sender terminal device 12, for example), a receiver (receiver terminal device 12, for example), the SNS server 10, a server other than the SNS server 10, or a combination of two or more of the sender, receiver, SNS server 10, and another device. That is, no limitation is imposed on the types and the number of devices to execute processing on content data. A user or an administrator, for example, may specify a device to execute processing on content data, and the content data may be subjected to processing by this specified device.

Specific examples of processing to be executed on content data are changing of the color of content data (such as the color of image data, the color of characters or the background of text data), trimming of content data (such as image data), changing of the shape of an object represented by image data (such as the shape of an object of a person, an animal, or another entity), retouching of content data (such as an object represented by image data or the characters or the background of text data), changing of the font of characters of text data, modifying the expression of text represented by text data (changing into honorific expressions or polite expressions, for example), changing of the style of text, and editing (modulating, for example) of sound data or music data. The above-described types of processing are merely examples, and another type of processing may be executed on content data. The sender of content data may specify the content of processing, or the SNS server 10 may suggest the specific content of processing.

In the exemplary embodiment, content data is sent and received between multiple users via SNS. Alternatively, content data may be sent and received via emails or online storages. When content data is sent and received via a medium other than SNS, processing is also executed on the content data in accordance with an attribute of the receiver of the content data, as in the use of SNS.

An example of the hardware configuration of the SNS server 10 will be described below with reference to FIG. 2.

The SNS server 10 includes a communication unit 14, a user interface (UI) 16, a memory 18, and a processor 20.

The communication unit 14 is a communication interface having a communication chip and a communication circuit, and has a function of sending data to another device and a function of receiving data from another device. The communication unit 14 may have a wireless communication function or a wired communication function. The communication unit 14 may communicate with another device by using short-range wireless communication or via a communication channel, such as a LAN or the Internet.

The UI 16 includes a display and an operation unit. The display is a liquid crystal display or an electroluminescence (EL) display, for example. The operation unit is a keyboard, input keys, or an operation panel, for example. The UI 16 may be a touchscreen which serves both as the display and the operation unit. The UI 16 may include a microphone and/or a speaker. The provision of the UI 16 in the SNS server 10 may be omitted.

The memory 18 is a device having one or multiple storage regions for storing various types of data. The memory 18 is one of a hard disk drive (HDD), various memory units (such as a random access memory (RAM), a dynamic random access memory (DRAM), and a read only memory (ROM)), and another type of storage device (such as an optical disc), or a combination thereof. The memory 18 included in the SNS server 10 is constituted by one or plural memory devices.

In the memory 18, user account information about users registered in SNS and another information, such as management information for managing various items of information, are stored. Examples of information stored in the memory 18 are user account information about users registered in SNS, information concerning groups, chat group management information for managing chat groups, user attribute management information for managing user attributes, attribute relationship management information for managing the relationship between attributes of plural users, processing content management information for managing the content of processing to be executed on content data, and information indicating the relationships between users.

The chat group management information is information for managing, for each chat group, users belonging to a chat group. For example, the chat group management information is information for linking, for each chat group, chat group identification information for identifying a chat group with user identification information for identifying each user belonging to this chat group. Checking the chat group management information makes it possible to identify users belonging to a certain chat group. Examples of the chat group identification information are a chat group ID and a chat group name. A task ID or a task name of a task, such as a specific meeting, conducted in a chat group may be an example of the chat group identification information. The user identification information is SNS user account information or information for identifying a user on SNS, such as a user ID, a user name, a nickname, or a handle.

The user attribute management information is information for managing, for each user, an attribute of a user. For example, the user attribute management information is information for linking, for each user, user identification information about a user with attribute information concerning an attribute of this user. A user attribute is an example of an attribute of a receiver of content data. Examples of a user attribute are the name, gender, age, address, nationality, family structure, friends, affiliation, educational background, work experience, hobbies, account, and account type. Among these items, one or more items may be used as an attribute of a user. Additionally, the terminal device 12 used by a user, application software installed in the terminal device 12, application software used by the user to use SNS, and SNS used by the user may be examples of an attribute of the user. The above-described attributes are only examples, and another attribute may be used as an attribute of a user.

For example, when a user is registered in the SNS server 10, attribute information indicating an attribute of the user is input with the terminal device 12, and the input attribute information is sent to the SNS server 10 and is registered in the user attribute management information. Attribute information concerning a user registered in the user attribute management information may be changed or deleted. New attribute information may be added to the user attribute management information. Attribute information may be changed, added, and deleted by the user having registered the attribute information or by the authorized administrator.

The attribute relationship management information is information for managing the relationship between an attribute of a user and that of another user. Hereinafter, the relationship between an attribute of a user and that of another user will simply be called the attribute relationship. The attribute relationship may be a relationship regarding the family, friends, job, and social hierarchy. The relationship regarding another element may be used as the attribute relationship. For example, a user inputs information indicating the relationship between an attribute of this user and that of another user (that is, the attribute relationship of the user having input the information) by using the terminal device 12, and this information is sent to the SNS server 10 and is registered in the attribute relationship management information. For example, information indicating the attribute relationship of a user is input when this user is registered in the SNS server 10 or sends content data or another timing. Information indicating the attribute relationship of a user registered in the attribute relationship management information may be changed or deleted. Information indicating a new attribute relationship may be added to the attribute relationship management information. Information indicating the attribute relationship may be changed, added, or deleted by the user having registered the information or by the authorized administrator.

The processing content management information is information for managing the content of processing to be executed on content data. The content of processing is changed in accordance with the above-described attribute relationship, and the processing content management information is information for managing the content of processing in accordance with the attribute relationship. For example, the processing content management information is information for linking, for each attribute relationship, information indicating the attribute relationship with information indicating the content of processing. The content of processing to be executed in accordance with the attribute relationship may be determined in advance or may be set or changed by the authorized administrator, for example.

The chat group management information, user attribute management information, attribute relationship management information, and processing content management information may be stored in a device other than the SNS server 10, such as in each terminal device 12 or another server.

The processor 20 controls the operations of the individual elements of the SNS server 10. For example, the processor 20 may communicate with other devices by using the communication unit 14, display information on the display of the UI 16, receive information input via the UI 16, store information in the memory 18, and read information from the memory 18. The processor 20 may include a memory.

The processor 20 provides a social networking service (SNS). For example, the processor 20 sends content data posted on SNS to a receiver of the content data.

The processor 20 manages a chat group. Managing of a chat group is forming a chat group, canceling a chat group, adding a new user to a chat group, and excluding a user from a chat group, for example.

In response to a request to form a chat group from an SNS member, the processor 20 forms a chat group. If a user wishes to join a chat group, the processor 20 may let this user join it if it has obtained approval from the current members of the chat group. In response to a request to exclude a member from a chat group from this member, the processor 20 may exclude this member from the chat group. The excluded member is no longer able to send and receive content data in this chat group.

The processor 20 also links chat group identification information for identifying a chat group with user identification information for identifying each user in this chat group, and stores chat group management information indicating the association between the chat group identification information and the user identification information in the memory 18.

The processor 20 also receives attribute information concerning an attribute of a user and registers the attribute information in the user attribute management information. Upon receiving an instruction to change or delete attribute information registered in the user attribute management information, the processor 20 may change or delete the attribute information.

The processor 20 also receives information indicating the attribute relationship and registers this information in the attribute relationship management information. Upon receiving an instruction to change or delete information indicating the attribute relationship registered in the attribute relationship management information, the processor 20 may change or delete the information.

The processor 20 may execute processing on content data. For example, the processor 20 may execute processing on content data in accordance with an attribute of the receiver of the content data or in accordance with the relationship between the sender and the receiver of the content data (attribute relationship, for example). The processor 20 identifies the relationship between an attribute of the sender user and that of the receiver user (that is, the attribute relationship) by referring to the attribute relationship management information, and then identifies the content of processing linked with the identified attribute relationship by referring to the processing content management information. The processor 20 then executes the identified content of processing on the content data. Instead of the processor 20, a device other than the SNS server 10 may execute processing on the content data.

The processor 20 may store in the memory 18 time information indicating the time (the date, for example) when a user in a chat group has joined this group by linking the time information with user identification information concerning this user. Checking this time information makes it possible to identify the time at which the user has joined the chat group. The processor 20 may store in the memory 18 time information indicating the time when a user is excluded from a chat group by linking the time information with user identification information concerning this user.

For example, if the user A in a chat group posts content data on this chat group by operating the terminal device 12A, the posted content data is sent from the terminal device 12A to the SNS server 10. The processor 20 of the SNS server 10 receives this content data and sends it to the terminal devices 12 of the other users in the chat group. For example, the posted content data, user identification information concerning the user A, and chat group identification information are sent from the terminal device 12A to the SNS server 10. The processor 20 then refers to the chat group management information so as to identify the user identification information concerning each user other than the user A linked with the chat group identification information. The processor 20 then sends the content data posted by the user A to the terminal devices 12 of the individual users indicated by the identified user identification information. Then, the content data posted by the user A is displayed on the terminal devices 12 of the users other than the user A. When a user other than the user A has posted content data, the processor 20 executes processing in a similar manner.

The processor 20 may manage a posting log of content data posted on SNS. For example, the processor 20 may manage, for each user, a posting log of content data posted by a user on SNS. The processor 20 may manage, for each chat group, a posting log of content data sent and received in a chat group. Log information indicating such a posting log is stored in the memory 18 or another server.

A program for implementing an automated response system may be stored in the memory 18, and the processor 20 may execute this program. This enables the automated response system to post data on SNS by using the SNS server 10.

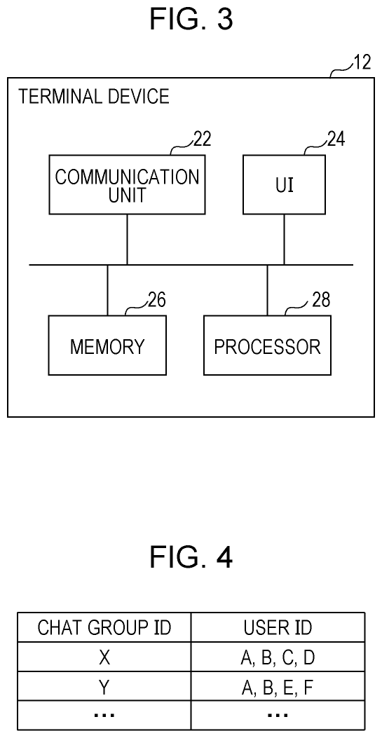

An example of the hardware configuration of the terminal device 12 will be described below with reference to FIG. 3.

The terminal device 12 includes a communication unit 22, a UI 24, a memory 26, and a processor 28.

The communication unit 22 is a communication interface having a communication chip and a communication circuit, and has a function of sending data to another device and a function of receiving data from another device. The communication unit 22 may have a wireless communication function or a wired communication function. The communication unit 22 may communicate with another device by using short-range wireless communication or via a communication channel, such as a LAN or the Internet.

The UI 24 includes a display and an operation unit. The display is a liquid crystal display or an EL display, for example. The operation unit is a keyboard, input keys, or an operation panel, for example. The UI 24 may be a touchscreen which serves both as the display and the operation unit. The UI 24 may include a microphone and/or a speaker.

The memory 26 is a device having one or multiple storage regions for storing various types of information. The memory 26 is one of an HDD, various memory units (such as a RAM, a DRAM, and a ROM), and another type of storage device (such as an optical disc), or a combination thereof. The memory 26 included in the terminal device 12 is constituted by one or plural memory devices.

In the memory 26, an SNS application program for using SNS provided by the SNS server 10 is stored. As a result of the processor 28 executing the SNS application program, SNS can be used in the terminal device 12.

In the memory 26, SNS user account information and attribute information indicating an attribute of the user using the terminal device 12 are stored. For example, in the memory 26 of the terminal device 12A, user account information about the user A and attribute information indicating an attribute of the user A may be stored. Attribute information indicating an attribute of a user other than the user A may be stored in the memory 26. For example, attribute information indicating an attribute of a user belonging to the same chat group as the user A may be stored in the memory 26. Information indicating the relationship between an attribute of the user A and that of another user (that is, the attribute relationship) may be stored in the memory 26. Information indicating the attribute relationship between users belonging to the same chat group as the user A may be stored in the memory 26. In the memory 26 of each terminal device 12, the above-described chat group management information, user attribute management information, attribute relationship management information, and processing content management information may be stored.

The processor 28 controls the operations of the individual elements of the terminal device 12. For example, the processor 28 may communicate with other devices by using the communication unit 22, display information on the display of the UI 24, receive information input via the UI 24, store information in the memory 26, and read information from the memory 26. The processor 28 may include a memory.

In response to an instruction from a user, the processor 28 sets SNS user account information and logs in SNS by using the SNS user account information. After having logged in SNS, the processor 28 posts content data on SNS in accordance with an instruction from the user. If a chat group is formed, the processor 28 may post content data on a chat group in accordance with an instruction from the user.

The processor 28 also displays a display region for displaying content data posted on SNS on the display of the UI 24. For example, if a chat group is formed, the display region is used for users participating in the chat group to share the content of a conversation made in the chat group.

The processor 28 also performs control so that processing is executed on content data. More specifically, the processor 28 executes processing on content data or instructs another device, such as the SNS server 10, to execute processing on content data. The processor 28 may execute part of processing on content data and instruct another device, such as the SNS server 10, to execute the remaining processing on the content data.

The processor 28 of the terminal device 12, which is the sender of content data, may execute processing on the content data and post it on SNS. For example, for each receiver user, the processor 28 of the sender terminal device 12 executes processing on content data in accordance with the relationship between an attribute of the sender user and that of a receiver user (that is, the attribute relationship). The processor 28 of the sender terminal device 12 refers to the attribute relationship management information and processing content management information stored in the memory 26 of the sender terminal device 12, the memory 18 of the SNS server 10, or another device so as to identify the content of processing associated with the attribute relationship, and executes the identified content of processing on the content data. The processor 28 of the sender terminal device 12 may not necessarily execute processing, but send information indicating the content of processing to the SNS server 10 and instruct it to execute processing on the content data. The processor 28 of the sender terminal device 12 may alternatively send this information to a receiver terminal device 12 via SNS and instruct it to execute processing on the content data.

In another example, upon receiving content data, the processor 28 of a receiver terminal device 12 may execute processing on the content data. For example, the processor 28 of the receiver terminal device 12 executes processing on the received content data in accordance with the relationship between an attribute of the receiver user and that of the sender user (that is, the attribute relationship). The processor 28 of the receiver terminal device 12 refers to the attribute relationship management information and processing content management information stored in the memory 26 of the receiver terminal device 12, the memory 18 of the SNS server 10, or another device so as to identify the content of processing associated with the attribute relationship, and executes the identified content of processing on the content data. The processor 28 of the receiver terminal device 12 may receive information indicating the content of processing associated with the attribute relationship from the sender terminal device 12 or the SNS server 10 and execute the content of processing indicated by this information on the content data.

Instead of the processor 28 of the terminal device 12, the SNS server 10 or another device may execute processing on content data.

The information processing system according to the exemplary embodiment will be described below in detail.

The chat group management information will be explained below in detail with reference to FIG. 4. FIG. 4 illustrates an example of a chat group management table, which is an example of the chat group management information. Data in the chat group management table is stored in the memory 18 of the SNS server 10. Data in the chat group management table may be stored in the memory 26 of each terminal device 12 or another server.

As shown in FIG. 4, in the chat group management table, for each chat group, the chat group ID, which is information for identifying a chat group, and the user ID, which is information for identifying a user belonging to this chat group, are linked with each other. The chat group ID is an example of the chat group identification information. The user ID is an example of the user identification information.

One or multiple users belong to one chat group. That is, one or multiple users belong to the same chat group. For example, users A, B, C, and D belong to chat group X having the chat group ID “X”. That is, the users A, B, C, and D participate in the same chat group X.

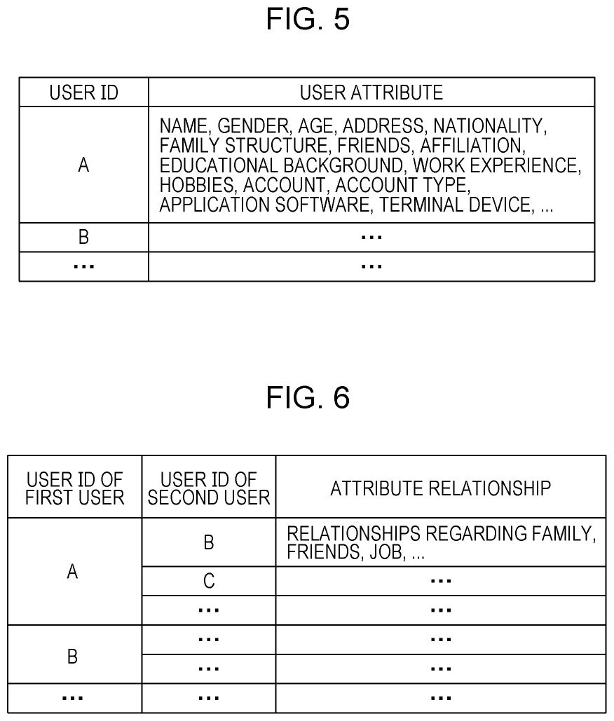

The user attribute management information will be explained below in detail with reference to FIG. 5. FIG. 5 illustrates an example of a user attribute management table, which is an example of the user attribute management information. Data in the user attribute management table is stored in the memory 18 of the SNS server 10. Data in the user attribute management table may be stored in the memory 26 of each terminal device 12 or another server.

As shown in FIG. 5, in the user attribute management table, for each user, the user ID of a user and attribute information indicating an attribute of the user are linked with each other. In the example in FIG. 5, concerning the user A, the name, gender, age, address, nationality, family structure, friends, affiliation, educational background, work experience, hobbies, account, account type, application software (application software used by the user A to use SNS, for example) installed in the terminal device 12 used by the user A, and the terminal device 12 are registered in the user attribute management table as attributes of the user A. These items are only examples and another item may be registered as an attribute of a user. When a user is registered in SNS, these items are input and registered in the user attribute management table by this user or the administrator. The items may be input and registered after the user is registered in SNS. Information registered in the user attribute management table may be changed or deleted by the user or the administrator. New information may be added to the user attribute management table.

The attribute relationship management information will be explained below in detail with reference to FIG. 6. FIG. 6 illustrates an example of an attribute relationship management table, which is an example of the attribute relationship management information. Data in the attribute relationship management table is stored in the memory 18 of the SNS server 10. Data in the attribute relationship management table may be stored in the memory 26 of each terminal device 12 or another server.

As shown in FIG. 6, in the attribute relationship management table, for each user, the user ID of a user (called a first user for the sake of convenience), the user ID of a user other than the first user (called a second user for the sake of convenience), and information indicating the attribute relationship, which is the relationship between an attribute of the first user and that of the second user, are linked with each other. Examples of the attribute relationship are relationships regarding the family, friends, job, and social hierarchy. These items are only examples, and another item may be registered in the attribute relationship management table as an attribute relationship. When a user is registered in SNS, these items are input and registered in the attribute relationship management table by this user or the administrator. The items may be input and registered after the user is registered in SNS. Information registered in the attribute relationship management table may be changed or deleted by the user or the administrator. New information may be added to the attribute relationship management table.

In one example, information indicating the attribute relationship, which is the relationship between an attribute of the user A, who is the first user, and that of the user B, who is the second user, is linked with the user ID of the user A and that of the user B and is registered in the attribute relationship management table. For example, if the user A is a parent of the user B, information indicating that the user A is a parent of the user B and the user B is a child of the user A is linked with the user ID of the user A and that of the user B and is registered in the attribute relationship management table as information indicating the attribute relationship between the user A and the user B. In another example, if the user A and the user B are close friends, information indicating that the user A and the user B are close friends is linked with the user ID of the user A and that of the user B and is registered in the attribute relationship management table as information indicating the attribute relationship between the user A and the user B.

Information indicating the relationships between users belonging to the same chat group may be stored in the attribute relationship management table. For example, if the user A, user B, and user C belong to the same chat group, information indicating the relationships among attributes of the user A, user B, and user C is registered in the attribute relationship management table.

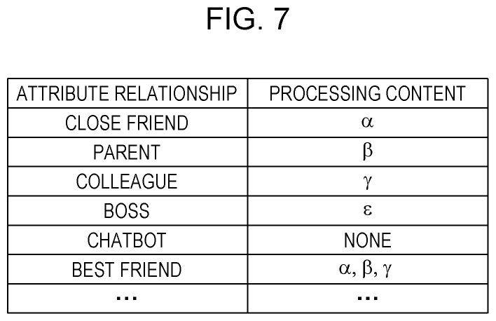

The processing content management information will be explained below in detail with reference to FIG. 7. FIG. 7 illustrates an example of a processing content management table, which is an example of the processing content management information. Data in the processing content management table is stored in the memory 18 of the SNS server 10. Data in the processing content management table may be stored in the memory 26 of each terminal device 12 or another server.

As shown in FIG. 7, in the processing content management table, for each attribute relationship, information indicating the attribute relationship and information indicating the content of processing to be executed on content data are linked with each other. One type of processing or plural types of processing may be linked with each attribute relationship.

For example, processing α is linked with the attribute relationship “close friend”. When the attribute relationship between an attribute of the sender of content data and that of the receiver of the content data is “close friend”, the processing α is executed on the content data.

Processing α, processing β, and processing γ are linked with the attribute relationship “best friend”. When the attribute relationship between an attribute of the sender of content data and that of the receiver of the content data is “best friend”, the processing α, processing β, and processing γ may all be executed on the content data, or one or multiple types of processing selected from the processing α, processing β, and processing γ may be executed on the content data. The sender user, the receiver user, or the administrator may select which processing will be executed on the content data. The processing α, processing β, and processing γ may be separately executed on the content data, and content data subjected to the processing α, content data subjected to the processing β, and the content data subjected to the processing γ may be individually generated.

The tables shown in FIGS. 4 through 7 are only examples, and the data structures of the individual tables may be different from those shown in FIGS. 4 through 7. The tables shown in FIGS. 4 through 7 may be integrated, and different items of information may be managed as one or multiple tables.

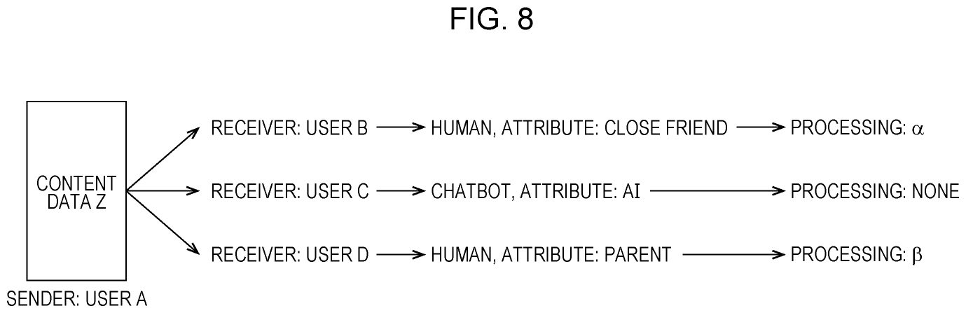

An example of processing to be executed on content data will be discussed below with reference to FIG. 8 through illustration of the following situation. The chat group X is formed. The users A, B, C, and D belong to the chat group X. The user A posts content data Z on the chat group X. That is, the user A sends the content data Z to the users B, C, and D together. The user A is a sender user, while the user B, user C, and user D are receiver users.

The content data Z posted by the user A, the user ID of the user A, and the chat group ID of the chat group X are sent from the terminal device 12A to the SNS server 10. The processor 20 of the SNS server 10 refers to the chat group management table such as that shown in FIG. 4 and identifies the user IDs of the users (users B, C, and D) belonging to the chat group X other than the user A linked with the chat group ID of the chat group X. The processor 20 then refers to the attribute relationship management table such as that shown in FIG. 6 and identifies the attribute relationship between the user A and each of the users B, C, and D. The processor 20 then refers to the processing content management table such as that shown in FIG. 7 and identifies the processing content linked with the attribute relationship between the user A and the user B, that between the user A and the user C, and that between the user A and the user D. For example, if the attribute relationship between the user A and the user B is “close friend”, the processing content is processing α. That is, the content of processing to be executed on the content data Z to be sent to the user B is determined to be the processing α. Likewise, the processor 20 identifies the attribute relationship between the user A and the user C and that between the user A and the user D, and determines the content of processing to be executed on the content data Z to be sent to the user C and that to the user D.

The processor 20 of the SNS server 10 executes processing on the content data Z in accordance with the attribute relationship between the sender and the receiver. For example, the processor 20 executes the processing α on the content data Z to be sent to the user B, does not execute any processing on the content data Z to be sent to the user C, and executes the processing β on the content data Z to be sent to the user D. The processor 20 then sends the resulting content data Z to the terminal device 12 of each receiver user. In this example, the processor 20 sends the content data Z subjected to the processing α to the terminal device 12B of the user B, the content data Z which is not subjected to any processing to the terminal device 12C of the user C, and the content data Z subjected to the processing β to the terminal device 12D of the user D. The resulting content data is displayed on the terminal device 12 of each receiver user. In this example, the content data Z subjected to the processing α is displayed on the display of the UI 24 of the terminal device 12B of the user B. The content data Z which is not subjected to any processing is displayed on the display of the UI 24 of the terminal device 12C of the user C. The content data Z subjected to the processing β is displayed on the display of the UI 24 of the terminal device 12D of the user D. In the example in FIG. 8, the user C is a chatbot realized by AI. In this manner, a non-human user, such as an automated response system, may participate in a chat group. Instead of using the terminal device 12C, the user C, such as a chatbot, may be installed in the SNS server 10 or another device and participate in the chat group X.

In the above-described example, the SNS server 10 executes processing on the content data Z. Alternatively, the sender terminal device 12, such as the terminal device 12A of the user A, or the receiver terminal device 12, such as the terminal device 12 of each of the users B, C, and D, may execute processing on the content data Z.

If the sender terminal device 12 executes processing on the content data Z, the processor 28 of the terminal device 12A of the sender user A refers to the chat group management table shown in FIG. 4 and identifies the user B, user C, and user D belonging to the chat group X other than the user A. The processor 28 then refers to the attribute relationship management table shown in FIG. 6 and identifies the attribute relationship between the user A and each of the users B, C, and D. The processor 28 then refers to the processing content management table shown in FIG. 7 and identifies the processing content associated with the attribute relationship between the user A and the user B, that between the user A and the user C, and that between the user A and the user D. The processor 28 then executes the identified content of processing on the content data Z. If data in the individual tables is stored in the terminal device 12A, the processor 28 of the terminal device 12A refers to the tables stored in the terminal device 12A. If data in the individual tables is stored in a device other than the terminal device 12A, such as in the SNS server 10, the processor 28 of the terminal device 12A refers to the tables stored in this device.

If a receiver terminal device 12 executes processing on the content data Z, the processor 28 of the terminal device 12B of the receiver user B, for example, receives the content data Z and the user ID of the user A having posted the content data Z. The processor 28 of the terminal device 12B then refers to the attribute relationship management table shown in FIG. 6 and identifies the attribute relationship between the user A and the user B. The processor 28 then refers to the processing content management table shown in FIG. 7 and identifies the processing α linked with the identified attribute relationship and executes the processing α on the content data Z. The processor 28 then displays the content data Z subjected to the processing α on the display of the UI 24 of the terminal device 12B. Likewise, the processor 28 of each of the user C and the user D determines the content of processing to be executed on the content data Z, executes the identified content of processing on the content data Z, and displays the resulting content data Z on the display.

As described above, for each receiver, processing is executed on content data in accordance with the attribute relationship between the sender and the receiver, and the content data subjected to processing is then sent to the receiver and is displayed at the receiver side. In this manner, even when the same content data is posted on the same chat group, different processing is executed on the content data in accordance with the attribute relationship between the sender and the receiver, and the resulting content data is sent to the receiver and is displayed. That is, even when the same content data is posted, it may be displayed differently at the receiver side depending on the attribute relationship between the sender and the receiver. As in the content data to be sent to the user C, such as a chatbot, processing may not be executed on content data depending on the relationship between the sender and the receiver.

Processing executed by the information processing system according to the exemplary embodiment will be described below in detail through illustration of the following specific example.

The chat group X is formed. Each member user logs in the SNS server 10 and participates in the chat group X.

For example, the user A, who is a member of the chat group X, requests the SNS server 10 to form the chat group X on SNS by operating the terminal device 12A. In response to this request, the processor 20 of the SNS server 10 forms the chat group X on SNS.

The user A provides an instruction to invite the user B, user C, and user D to the chat group X by operating the terminal device 12A. Then, information indicating this instruction is sent from the terminal device 12A to the SNS server 10. Upon receiving this information, the processor 20 of the SNS server 10 lets the users B, C, and D become members of the chat group X. Information indicating an invitation to the chat group X may be sent to the users B, C, and D. In this case, when a user has accepted the invitation, the processor 20 of the SNS server 10 may let this user become a member of the chat group X.

In another example, the user B requests the SNS server 10 to let the user B join the chat group X by operating the terminal device 12B. Then, the processor 20 of the SNS server 10 may let the user B become a member of the chat group X. Likewise, in response to a request from the user C or the user D, the processor 20 of the SNS server 10 may let the user join the chat group X.

In the above-described example, the user A has formed the chat group X. Alternatively, another user may form the chat group X.

If a user authorized to form a chat group requests the SNS server 10 to form one, the processor 20 of the SNS server 10 may form this chat group. If a user authorized to invite another user to a chat group requests the SNS server 10 to invite this user to the chat group, the processor 20 may let this user become a member of the chat group.

The processor 20 of the SNS server 10 manages the chat group X. More specifically, the processor 20 links the chat group ID of the chat group X and the user IDs of the users A, B, C, and D, who are members of the chat group X, with each other, and registers the chat group ID and the user IDs in the chat group management table, such as that shown in FIG. 4. The processor 20 may not necessarily use such a management table to manage the chat group X. The processor 20 may also register time information indicating the time (the date, for example) when each member user has joined the chat group X in the chat group management table.

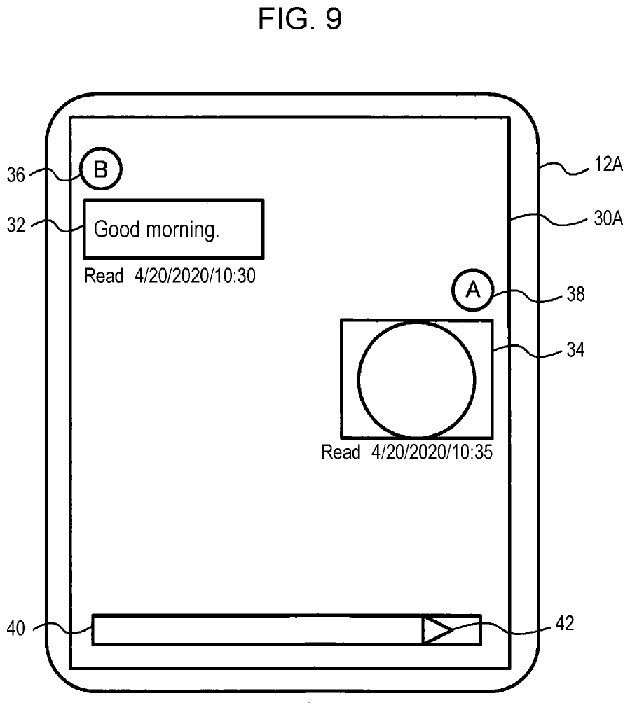

FIG. 9 illustrates a screen 30A, which is an example of the screen displayed when content data is sent and received among the users A, B, C, and D in the chat group X. The screen 30A shown in FIG. 9 is a chat screen displayed on the display of the UI 24 of the terminal device 12A used by the user A. The processor 28 of the terminal device 12A displays the screen on the display of the UI 24. The screen 30A corresponds to an example of the display region used for multiple users in the chat group X to share the content of a conversation. On the screen 30A, content data posted by each user in the chat group X is displayed. In one example, a conversation made by the users in the chat group X is displayed in a chat conversation format. More specifically, a conversation in the chat group X is carried out while individual users are giving a message to each other.

For example, in response to an instruction to start the SNS application program from the user A using the terminal device 12A, the processor 28 of the terminal device 12A displays the SNS screen, such as a menu screen, on the display of the UI 24 of the terminal device 12A. In response to a request to participate in the chat group X from the user A, the processor 28 displays the screen 30A shown in FIG. 9 on the display of the UI 24 of the terminal device 12A.

The processor 28 of the terminal device 12A displays content data posted on the chat group X on the screen 30A. For example, the processor 28 displays content data posted by the user A on the screen 30A. The processor 28 also receives via the SNS server 10 content data posted on the chat group X by a user other than the user A and displays the received content data on the screen 30A. For example, the processor 28 rearranges pieces of content data posted on the chat group X in chronological order and displays them on the screen 30A. As the conversation continues on the screen 30A, the processor 28 scrolls on the screen 30A to display the latest content data on the screen 30A.

The processor 28 of the terminal device 12A displays user identification information for identifying each user participating in the chat group X on the screen 30A. For example, the processor 28 displays content data posted by a certain user on the screen 30A by linking the content data with user identification information about this user. Examples of the user identification information are an image representing a user, a character string for identifying a user (such as the name, user ID, handle, and nickname), and a combination of an image and a character string.

For example, on the screen 30A displayed on the terminal device 12A of the user A, content data posted by the user A is displayed on the right side, while content data posted by a user other than the user A (users B, C, and D, for example) is displayed on the left side. This display format is only an example, and another format may be used. For example, content data posted by one user and that by another user may separately be displayed on the top side and the bottom side or be displayed in the same region.

In the example in FIG. 9, content data 32 and content data 34 are displayed on the screen 30A. The content data 32 is a text message posted by the user B on the chat group X, while the content data 34 is image data posted by the user A on the chat group X.

An image 36 representing the user B is linked with the content data 32 posted by the user B and is displayed on the screen 30A. An image 38 representing the user A is linked with the content data 34 posted by the user A and is displayed on the screen 30A. In the example in FIG. 9, the image 36 is displayed above the content data 32, while the image 38 is displayed above the content data 34. This display format is only an example, and content data and other data may be displayed in another display format. In addition to or instead of an image representing a user, a character string, such as a user ID or a user name, may be displayed.

On the screen 30A, an input field 40 and a send button 42 are also displayed. When a message is input into the input field 40 and the send button 42 is selected, the processor 28 of the terminal device 12A posts this message on the chat group X as content data. A button and a field for selecting image data or sound data, for example, as content data may be displayed on the screen 30A, and when the button is selected, the corresponding image data or sound data may be posted as content data.

For example, when the user A inputs a message into the input field 40 and presses the send button 42, the processor 28 of the terminal device 12A posts this message on the chat group X as content data, which is a remark of the user A. That is, this message is displayed as what the user A has said.

A button for displaying a selection screen to select image data or sound data, for example, may be displayed on the screen 30A. When the user A presses this button, the selection screen may be displayed on the screen 30A. The user A selects on the selection screen image data or sound data to be posted on the chat group X and presses the send button 42, and then, the selected image data or sound data is posted on the chat group X as content data.

Content data, such as text data, image data, or sound data, posted in the above-described manner is subjected to processing in accordance with the attribute relationship between the sender user and the receiver user, and is then displayed on the terminal device 12 of the receiver user.

On the terminal device 12 of a user other than the user A, a screen similar to the screen 30A is displayed.

Hereinafter, the screen 30A for the chat group X displayed on the display of the UI 24 of the terminal device 12A of the user A may simply be called the screen 30A for the user A. The screen for the chat group X displayed on the display of the UI 24 of the terminal device 12 of another user may also be called in a similar manner (the screen 30B for the user B, for example).

The content data shown in FIG. 9 is sent to the terminal device 12 of each user participating in the chat group X via the SNS server 10. For example, when the user A has posted the content data 34, which is image data, on the chat group X by operating the terminal device 12A, the content data 34, the user ID of the user A, and the chat group ID of the chat group X are sent from the terminal device 12A to the SNS server 10. The processor 20 of the SNS server 10 refers to the chat group management table such as that shown in FIG. 4 and identifies the user IDs of the users B, C, and D other than the user A linked with the chat group ID of the chat group X. The processor 20 then refers to the attribute relationship management table such as that shown in FIG. 6 and identifies the attribute relationship between the user A and each of the users B, C, and D. The processor 20 then refers to the processing content management table such as that shown in FIG. 7 and identifies the processing content linked with each of the attribute relationships. The processor 20 then executes the processing α on the content data 34 to be sent to the user B, does not execute any processing on the content data 34 to be sent to the user C, and executes the processing β on the content data 34 to be sent to the user D. The processor 20 then sends the content data 34 subjected to the processing α to the terminal device 12B of the user B, the content data 34 which is not subjected to any processing to the terminal device 12C of the user C, and the content data 34 subjected to the processing β to the terminal device 12D of the user D. On the screen 30B displayed on the terminal device 12B, the content data 34 subjected to the processing α is displayed as a message of the user A. On the screen 30C displayed on the terminal device 12C, the content data 34 which is not subjected to any processing is displayed as a message of the user A. On the screen 30D displayed on the terminal device 12D, the content data 34 subjected to the processing β is displayed as a message of the user A. The entirety or part of processing executed by the processor 20 may be executed by the sender terminal device 12, the receiver terminal devices 12, or another device.

The content data 32 and the content data 34 are rearranged in chronological order and are displayed from the top to the bottom of the screen 30A. Content data posted earlier than the content data 32 may be displayed by scrolling on the screen 30A.

Information indicating the date on which content data is posted may be linked with the content data and be displayed. For example, the content data 32 is posted on Apr. 20, 2020 at 10:30, and a character string representing the date is linked with the content data 32 and is displayed on the screen 30A. The character string indicating the date is displayed around the display position of the content data 32, for example (under the content data 32 in FIG. 9). Other content data may be displayed in a similar manner. A mark indicating that content data is read by another user, such as a “read” mark, may be linked with the content data and be displayed. The number of users having read content data may be linked with the content data and be displayed.

On the screen 30A displayed on the terminal device 12A of the user A having sent the content data 34, the content data 34 which is not subjected to processing is displayed. That is, the processor 28 of the sender terminal device 12A displays on the screen 30A the content data 34 posted by the user A as data which is not subjected to processing.

The processor 28 of the terminal device 12A may display the content data 34 subjected to processing on the screen 30A. For example, the processor 28 may display both of the content data 34 subjected to the processing α and the content data 34 subjected to the processing β on the display 30A, in addition to or instead of the content data 34 which is not subjected to processing.

In response to an instruction to display the content data 34 subjected to processing from the user A using the terminal device 12A, the processor 28 may display the content data 34 subjected to processing on the screen 30A.

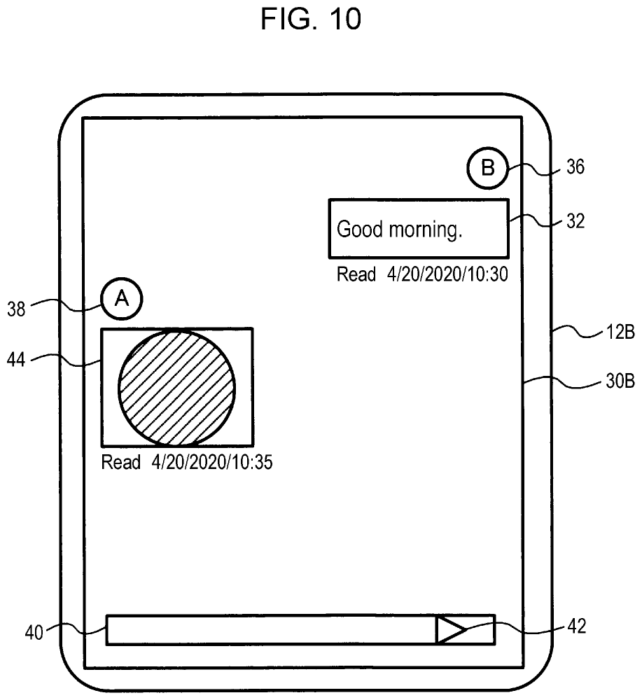

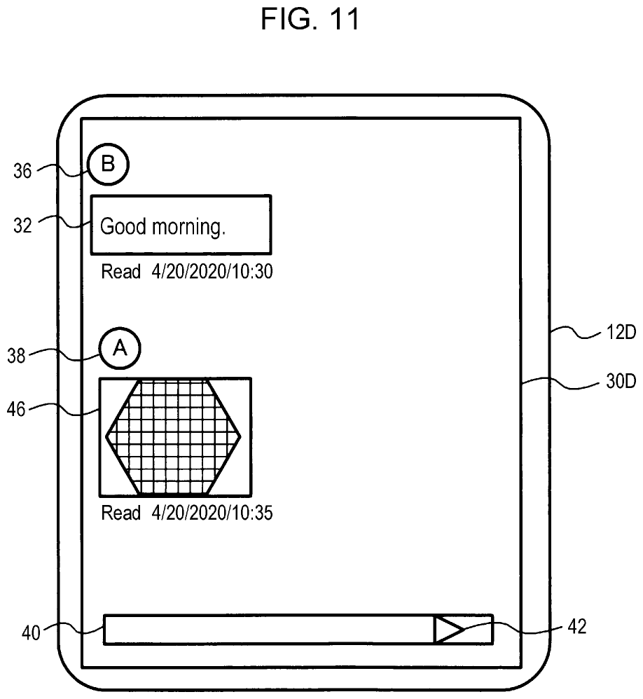

Screens displayed on the receiver terminal devices 12 having received content data will be discussed below with reference to FIGS. 10 and 11. FIG. 10 illustrates a screen displayed on the display of the UI 24 of the terminal device 12B of the user B. FIG. 11 illustrates a screen displayed on the display of the UI 24 of the terminal device 12D of the user D.

The processor 28 of the receiver terminal device 12 receives content data from the sender terminal device 12, and displays the content data which is subjected to processing in accordance with the attribute relationship between the sender and the receiver on the display of the UI 24. If the sender terminal device 12 or the SNS server 10 executes processing on the content data, the receiver terminal device 12 receives and displays the content data subjected to processing. If the receiver terminal device 12 executes processing on the content data received from the sender terminal device 12, it receives the content data which has not been subjected to processing, and executes processing on the content data and displays it.

For example, the processor 28 of the receiver terminal device 12B receives content data (content data which is subjected to the processing α or which is not subjected to the processing α) sent from the sender terminal device 12A. If the received content data has been subjected to the processing α, the processor 28 of the terminal device 12B displays the content data. If the received content data has not been subjected to the processing α, the processor 28 executes the processing α on the received content data and displays it. The terminal devices 12C and 12D receive and display content data sent from the terminal device 12A in a similar manner.

As shown in FIG. 10, the content data 32 and content data 44 are displayed on the screen 30B for the user B. The content data 32 is that posted by the user B on the chat group X. The content data 44 is that posted by the user A on the chat group X and has been subjected to the processing α in accordance with the attribute relationship between the user A and the user B. That is, as a result of executing the processing α on the content data 34 posted by the user A shown in FIG. 9, the content data 44 is generated and is displayed on the screen 30B for the user B. The image 38 representing the user A having posted the content data 34 is linked with the content data 44 and is displayed on the screen 30B. As discussed above, any one of the terminal device 12A, the SNS server 10, the terminal device 12B, and another device may execute the processing α on the content data 34.

The content data 44 may be a thumbnail image, that is, a reduced size image. In this case, the processor 28 of the terminal device 12B may reflect the processing α in the thumbnail image. The content data 44 shown in FIG. 10 is a thumbnail image in which the processing α is reflected. For example, the user B selects the content data 44, which is a thumbnail image, and gives an instruction to enlarge it. Then, the processor 28 of the terminal device 12B enlarges the content data 44 and displays the enlarged content data 44 on the screen 30B.

As shown in FIG. 11, the content data 32 and content data 46 are displayed on the screen 30D for the user D. The content data 32 is that posted by the user B on the chat group X. The content data 46 is that posted by the user A on the chat group X and has been subjected to the processing β in accordance with the attribute relationship between the user A and the user D. That is, as a result of executing the processing β on the content data 34 posted by the user A shown in FIG. 9, the content data 46 is generated and is displayed on the screen 30D for the user D. The image 38 representing the user A having posted the content data 34 is linked with the content data 46 and is displayed on the screen 30D. As discussed above, any one of the terminal device 12A, the SNS server 10, the terminal device 12D, and another device may execute the processing β on the content data 34.

As in the content data 44 displayed for the user B, the content data 46 may be a thumbnail image. In this case, the processor 28 of the terminal device 12D may reflect the processing β in the thumbnail image. The content data 46 shown in FIG. 11 is a thumbnail image in which the processing β is reflected. For example, the user D selects the content data 46, which is a thumbnail image, and gives an instruction to enlarge it. Then, the processor 28 of the terminal device 12D enlarges the content data 46 and displays the enlarged content data 46 on the screen 30D.

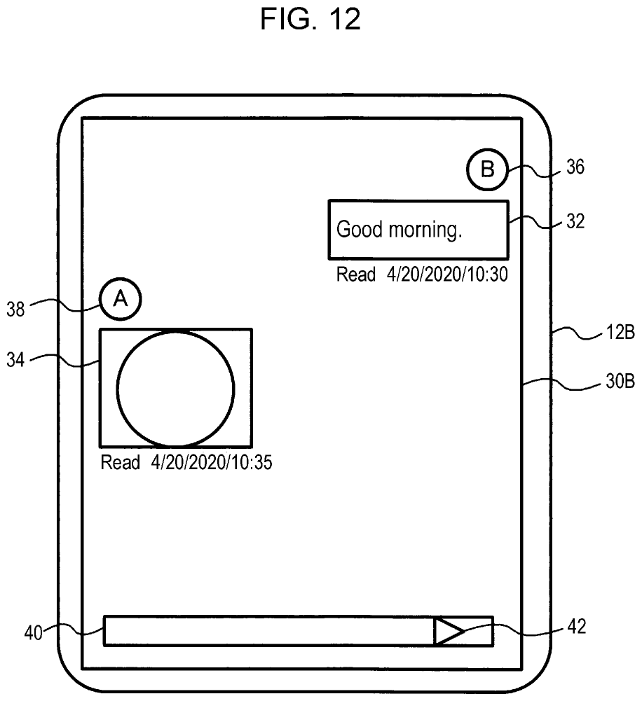

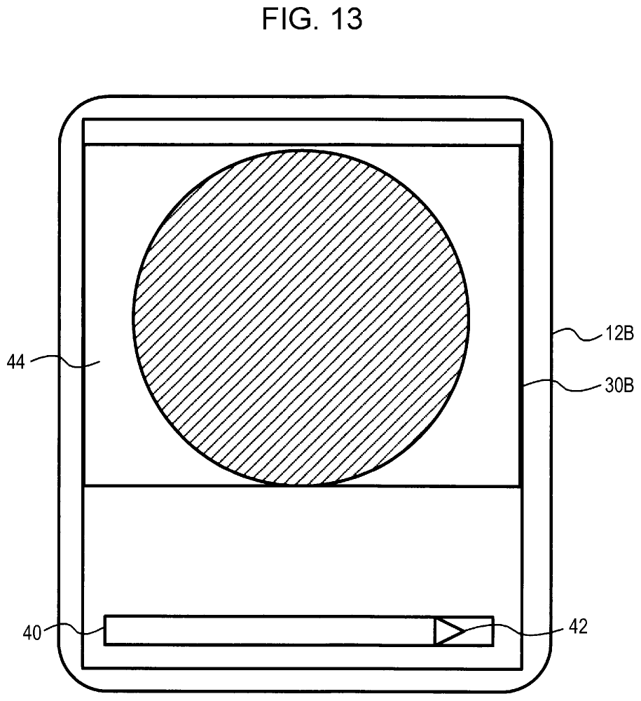

Another display example of content data will be discussed below with reference to FIGS. 12 and 13. The screen 30B for the user B is shown in FIGS. 12 and 13.

In the example in FIG. 12, the processor 28 of the terminal device 12B displays the content data 34 which has not been subjected to the processing α on the screen 30B as a thumbnail image. That is, the content data 34 in which the processing α has not been reflected is displayed on the screen 30B as a thumbnail image. For example, the processor 28 of the terminal device 12B receives the content data 34 which has not been subjected to the processing α from the terminal device 12A and displays the content data 34 as it is on the screen 30B as a thumbnail image.

The user B selects the content data 34, which is a thumbnail image, and gives an instruction to enlarge it. Then, the processor 28 of the terminal device 12B displays the enlarged content data 44 in which the processing α is reflected, as shown in FIG. 13. For example, in response to an instruction to enlarge the content data 34, the processor 28 executes the processing α on the content data 34 so as to generate the content data 44. The processor 28 then enlarges the content data 44 and displays it on the screen 30B. Alternatively, the processor 28 of the terminal device 12B may receive both of the content data 34 which has not been subjected to the processing α and the content data 44 which has been subjected to the processing α from the terminal device 12A. In response to an instruction to enlarge the content data, the processor 28 may enlarge the content data 44 and display it on the screen 30B.

As discussed above, the processor 28 of a receiver terminal device may display a thumbnail image in which processing is reflected (such a display approach will be called approach 1 for the sake of convenience), as shown in FIGS. 10 and 11. Alternatively, the processor 28 may first display a thumbnail image in which processing is not reflected and then display the thumbnail image in which processing is reflected in response to an instruction to enlarge the thumbnail image (such a display approach will be called approach 2 for the sake of convenience), as shown in FIGS. 12 and 13. A sender user or a receiver user may determine which approach the processor 28 of the receiver terminal device will employ to display a thumbnail image. The processor 28 then displays the thumbnail image in accordance with an instruction from the sender user or the receiver user.

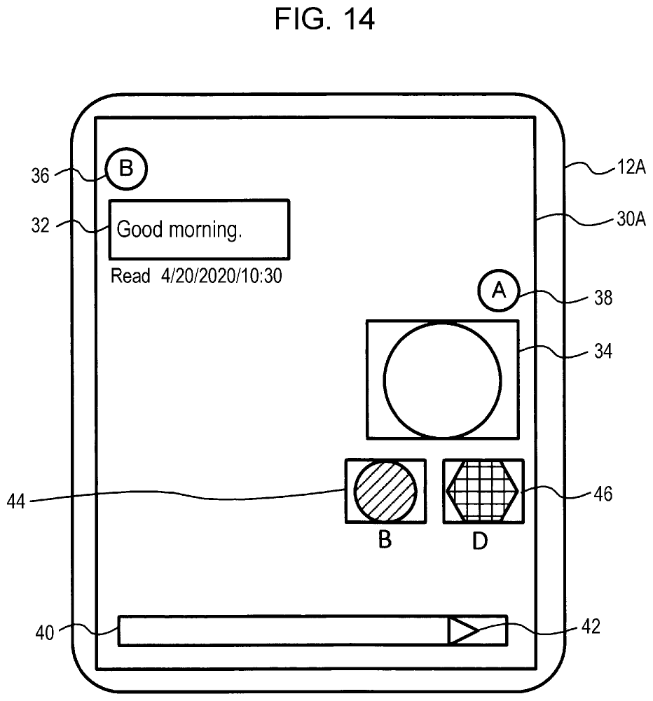

Another example of the screen displayed on a sender terminal device 12 will be discussed below with reference to FIG. 14. The screen 30A for the user A is shown in FIG. 14. In the example in FIG. 9, the processor 28 of the terminal device 12A displays the content data 34 which has not been subjected to processing on the screen 30A. In the example in FIG. 14, the processor 28 of the terminal device 12A displays on the screen 30A both of the content data 34 which has not been subjected to processing and content data subjected to processing. For example, the processor 28 of the terminal device 12A displays on the screen 30A the content data 44 generated as a result of executing the processing α on the content data 34 for the user B and the content data 46 generated as a result of executing the processing β on the content data 34 for the user D. The content data 44 and the content data 46 are displayed side by side as thumbnail images. Displaying the content data 44 and content data 46 on the screen 30A enables the sender user A to check the content data subjected to processing to be sent to the user B and that to the user D.

The user identification information indicating the sender user (such as the user ID or the user name) may be linked with the content data 44 and the content data 46 and be displayed. For example, a character string representing the user B may be linked with the content data 44 and be displayed under the content data 44. Likewise, a character string representing the user D may be linked with the content data 46 and be displayed under the content data 46.

For example, the sender user A selects the content data 44 or 46 and gives an instruction to enlarge the selected content data. Then, the processor 28 of the terminal device 12A may enlarge the selected content data and display it on the screen 30A.

Although in the example in FIG. 14 the content data 34 which has not been subjected to processing is also displayed on the screen 30A, it may not necessarily be displayed on the screen 30A.

In the above-described exemplary embodiment, processing based on the attribute relationship between a sender and a receiver is executed on content data for each receiver user. Alternatively, processing based on the attribute relationship between a sender and a receiver may be executed on content data for each SNS account. For example, if one user has multiple accounts, processing is executed on content data for each SNS account.

This will be discussed through illustration of a specific example. It is assumed that the user A has account A1 and account A2. If the user A has logged in the SNS server 10 with the account A1 and posted content data on the chat group X, processing is executed on the content data in accordance with the attribute relationship between the account A1 and the user B, and the resulting content data is displayed on the terminal device 12B of the user B. Likewise, for the user C or D, processing is executed on content data and is displayed in a similar manner. If the user A has logged in the SNS server 10 with the account A2 and posted content data on the chat group X, processing is executed on the content data in accordance with the attribute relationship between the account A2 and the user B, and the resulting content data is displayed on the terminal device 12B of the user B.

Modified examples will be described below.

Processing to be executed on content data may be changed in accordance with application software used by a receiver to receive the content data. For example, if content data is sent and received with SNS, the application software used by a receiver to receive the content data is SNS application software. If content data is sent and received with a technology other than SNS, such as with an email or an online storage, the application software used by a receiver to receive the content data is application software for this technology, such as email software or online storage software.

It is assumed that SNS application software B1 is installed in the terminal device 12B of the receiver user B and the user B is using the application software B1, while SNS application software C1 is installed in the terminal device 12C of the receiver user C and the user C is using the application software C1. The application software B1 and the application software C1 are different software, and SNS (B1) that can be used with the application software B1 and SNS (C1) that can be used with the application software C1 are different SNSs.

In this case, even when the same content data Z is sent to the terminal devices 12B and 12C, processing executed on the content data Z for the user B and that for the user C are different. The content data Z subjected to processing for the user B is displayed on the terminal device 12B, while the content data Z subjected to processing for the user C is displayed on the terminal device 12C. For example, processing suitable for the application software B1 is executed on the content data Z and the resulting content data Z is displayed on the terminal device 12B. Likewise, processing suitable for the application software C1 is executed on the content data Z and the resulting content data Z is displayed on the terminal device 12C. For example, processing to be executed on content data may be limited depending on the type of SNS application software, in which case, processing is executed on the content data Z within the limitations.

Processing based on application software may be executed by the SNS server 10, a sender terminal device 12, a receiver terminal device 12, or another device, as in the above-described exemplary embodiment.

In one example, information concerning application software installed in each terminal device 12 and information indicating processing suitable for each application software may be stored in the SNS server 10. By referring to these items of information, the processor 20 of the SNS server 10 identifies the type of processing suitable for the SNS application software used by a receiver terminal device 12 and executes the identified type of processing on content data. Alternatively, the processor 28 of a sender terminal device 12 may refer to information concerning the application software installed in the receiver terminal device and execute processing suitable for the application software on content data. In another example, the processor 28 of a receiver terminal device 12 receives content data which has not been subjected to processing and executes the type of processing suitable for the SNS application software installed in the receiver terminal device 12 on the content data.

In another example, processing to be executed on content data may be changed in accordance with the relationship between application software used by a sender to send content data and that by a receiver to receive the content data.

A specific example will be given. SNS application software A1 is installed in the sender terminal device 12A of the user A and the user A is using the SNS application software A1. SNS application software B1 is installed in the receiver terminal device 12B of the user B and the user B is using the SNS application software B1. SNS application software C1 is installed in the receiver terminal device 12C of the user C and the user C is using the SNS application software C1. It is now assumed that SNS (A1) can be used with the application software A1, SNS (B1) can be used with the application software B1, and SNS (C1) can be used with the application software C1. The SNS application software used by a sender and that by a receiver may be the same or different from each other. That is, SNS used by a sender and that by a receiver may be the same or different.

In this case, processing (processing α, for example) based on the relationship between the sender application software (A1) and the receiver application software (B1) is executed on the content data Z to be sent from the sender terminal device 12A to the receiver terminal device 12B, and the content data Z subjected to the processing α is displayed on the terminal device 12B.

Likewise, processing (processing β, for example) based on the relationship between the sender application software (A1) and the receiver application software (C1) is executed on the content data Z to be sent from the sender terminal device 12A to the receiver terminal device 12C, and the content data Z subjected to the processing β is displayed on the terminal device 12C.

Processing based on the relationship between sender application software and receiver application software may be executed by the SNS server 10, a sender terminal device 12, a receiver terminal device 12, or another device, as in the above-described exemplary embodiment.

For example, information concerning application software installed in each terminal device 12 and information indicating processing to be executed based on the relationship between a combination of application software items are stored in the SNS server 10. By referring to these items of information, the processor 20 of the SNS server 10 identifies the type of processing to be executed based on the relationship between the application software used by a sender terminal device 12 and that by a receiver terminal device 12 and executes the identified type of processing on content data. Alternatively, by referring to the above-described items of information, the processor 28 of the sender terminal device 12 or the receiver terminal device 12 may execute processing based on the relationship between the sender application software and the receiver application software.

In this manner, processing that can be executed on content data may be changed in accordance with a combination of SNS application software items. For example, with a combination of SNS application software A1 and SNS application software B1, the processing α can be executed on content data, but it is not possible to execute the processing β. More specifically, when content data sent with the application software A1 is received with the application software B1, the processing α can be executed on the content data, but it is not possible to execute the processing β because the standard or the version of the application software A1 and that of the application software B1 are different from each other, for example. In this case, the processing α is executed on the content data. Processing that can be executed on content data may also be limited with a combination of the application software A1 and the application software C1.

In the embodiment above, the term “processor” refers to hardware in a broad sense. Examples of the processor include general processors (e.g., CPU: Central Processing Unit) and dedicated processors (e.g., GPU: Graphics Processing Unit, ASIC: Application Integrated Circuit, FPGA: Field Programmable Gate Array, and programmable logic device).

In the embodiment above, the term “processor” is broad enough to encompass one processor or plural processors in collaboration which are located physically apart from each other but may work cooperatively. The order of operations of the processor is not limited to one described in the embodiment above, and may be changed.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to
perform control so that processing is executed on content data in accordance with an attribute of a receiver of the content data, and
send the content data to the receiver.

2. The information processing apparatus according to claim 1, wherein the processing to be executed on the content data is changed in accordance with a relationship between a sender and the receiver of the content data.

3. The information processing apparatus according to claim 2, wherein the processor is further configured to:
send the content data to a plurality of receivers,
wherein, for each of the plurality of receivers, the processing to be executed on the content data is changed in accordance with the sender and a corresponding receiver.

4. The information processing apparatus according to claim 1, further comprising:
a display,
wherein the processor is further configured to
display the content data which has not been subjected to the processing on the display.

5. The information processing apparatus according to claim 2, further comprising:
a display,
wherein the processor is further configured to
display the content data which has not been subjected to the processing on the display.

6. The information processing apparatus according to claim 3, further comprising:
a display,
wherein the processor is further configured to
display the content data which has not been subjected to the processing on the display.

7. The information processing apparatus according to claim 1, further comprising:
a display,
wherein the processor is further configured to
display the content data which has been subjected to the processing on the display.

8. The information processing apparatus according to

2. , wherein the processor is further configured to:
display the content data which has been subjected to the processing on the display.

9. The information processing apparatus according to claim 3, further comprising:
a display,
wherein the processor is further configured to
display the content data which has been subjected to the processing on the display.

10. The information processing apparatus according to claim 4, further comprising:
a display,
wherein the processor is further configured to
display the content data which has been subjected to the processing on the display.

11. The information processing apparatus according to claim 5, further comprising:
a display,
wherein the processor is further configured to
display the content data which has been subjected to the processing on the display.

12. The information processing apparatus according to claim 6, further comprising:
a display,
wherein the processor is further configured to
display the content data which has been subjected to the processing on the display.

13. An information processing apparatus comprising:
a processor configured to
receive content data sent from a sender, and
display the received content data on a display as content data which has been subjected to processing in accordance with a receiver of the content data.

14. The information processing apparatus according to claim 13, wherein the processor is further configured to:
display the received content data on the display as a thumbnail image; and
reflect the processing in the thumbnail image, or reflect the processing in the thumbnail image when the thumbnail image is selected and the content data is enlarged and is displayed on the display.

15. The information processing apparatus according to claim 1, wherein the processing to be executed on the content data is changed in accordance with application software used by the receiver of the content data to receive the content data.

16. The information processing apparatus according to claim 13, wherein the processing to be executed on the content data is changed in accordance with application software used by the receiver of the content data to receive the content data.

17. The information processing apparatus according to claim 15, wherein the processing to be executed on the content data is changed in accordance with a relationship between application software used by the sender to send the content data and application software used by the receiver to receive the content data.

18. The information processing apparatus according to claim 15, wherein the application software is application software used for a social networking service, the social networking service being used for sending and receiving information between a sender and a receiver.

19. A non-transitory computer readable medium storing a program causing a computer to execute a process, the process comprising:
performing control so that processing is executed on content data in accordance with an attribute of a receiver of the content data; and
sending the content data to the receiver.

20. A non-transitory computer readable medium storing a program causing a computer to execute a process, the process comprising:
receiving content data sent from a sender; and
displaying the received content data on a display as content data which has been subjected to processing in accordance with a receiver of the content data.
